(19) United States
(12) Patent Application Publication
(10) Pub. No.: US 2005/0192860 A1
(43) Pub. Date: Sep. 1, 2005

(54) Supplemental parts production forecasting system, supplemental parts production forecasting method, and program for the same

(75) Inventors: Toshihiko Kouda, Tokyo (JP); Takao Nagai, Tokyo (JP)

Correspondence Address: FRISHAUF, HOLTZ, GOODMAN & CHICK, PC, 220 5TH AVE FL 16, NEW YORK, NY, 10001-7708, US

(73) Assignee: KOMATSU LTD., Tokyo (JP)

(21) Appl. No.: 11/008,512

(22) Filed: Dec. 9, 2004

(30) Foreign Application Priority Data
Dec. 11, 2003 (JP) 2003-413314

(51) Int. Cl. G06F 17/60

(52) U.S. Cl. 705/10

(57) ABSTRACT

Error information and alarm information transmitted from a construction machine (2) is fetched by a server (8). A replacement possibility determining section (815) in the server (8) determines a utilization area of the construction machine (2) from positional information stored in a positional information database (825), and reads out a load to the parts in the utilization area (lifetime of parts in the utilization area) from a utilization environment load database (827). When the parts having transmitted the error information or alarm information has reached the lifetime limit in the utilization area and accumulated utilization time of the construction machine is not less than a prespecified utilization time, or when times of transmission of the error information is not less than prespecified times or duration of transmission of the alarm information is not less than a prespecified period of time, the replacement possibility determining section (815) determines that the parts having transmitted the error information or alarm information is an object for replacement.

### BACKGROUND OF THE INVENTION

1. Field of the Invention

The present invention relates to a supplemental parts production forecasting system, a supplemental parts production forecasting method, and a program for the same.

2. Description of Related Art

Various types of parts are used in construction machines used at a site of construction work such as a bulldozer, a power shovel and the like. As the parts are worn out or depleted during the construction work, the parts are replaced with a new one according to the necessity (Refer to, for instance, REFERENCE: Japanese Patent Publication No. 2002-138517, pages 4 to 9).

The supplemental parts supplied in association with the replacement of parts described above are produced based on a designed lifetime set when the parts are designed or an actual result of demand for the parts in the past.

However, in the method in which supplemental parts are produced based on a designed lifetime of the parts or an actual result of demand for the parts in the past, the production method is not based on considerations concerning the current operating state of the machine, sometimes an actual production quantity of the supplemental parts is different from an actual demand for the parts. Because of this difference, sometimes unnecessary stocks for the supplemental parts are generated or necessary supplemental parts are in short supply.

### SUMMARY OF THE INVENTION

An object of the present invention is to provide a supplemental parts production forecasting system enabling optimization of a production quantity of supplemental parts, a supplemental parts production forecasting method, and a program for the same.

According to an aspect of the present invention, a supplemental parts production forecasting system for forecasting production, when an abnormality occurs in parts constituting a machine, of supplemental parts to be replaced with the parts includes: an error/alarm information fetching section for fetching error information or alarm information transmitted from the machine and indicating parts with abnormality and contents of the abnormality in the machine; a utilization record fetching section for fetching utilization record of the machine transmitted from the machine; a utilization record accumulating section for sequentially accumulating the fetched utilization records; a replacement possibility determining section for determining whether the parts with the abnormality generated therein is an object for replacement with supplemental parts or not based on the error information or alarm information fetched by the error/alarm fetching section as well as on the utilization record accumulated in the utilization record accumulating section; and a production forecasting section for forecasting production of the supplemental parts to be replaced with the parts when it is determined that replacement of the parts is necessary by the replacement possibility determining section.

Here, the utilization record includes times of transmission of the error information, duration of the transmission of the alarm information, the accumulated utilization time of the machine, and the like.

In the supplemental parts production forecasting system of the present invention, it is preferable that the utilization record includes times of transmission of the error information or duration of transmission of the alarm information from the machine.

In the supplemental parts production forecasting system of the present invention, it is preferable that the utilization record includes accumulated utilization time of the machine.

Preferably, the supplemental parts production forecasting system of the present invention further includes: a positional information fetching section for fetching information concerning a position of utilization of the machine transmitted from the machine.

Preferably, the supplemental parts production forecasting system of the present invention further includes: a designed lifetime storing section for storing therein designed lifetimes for parts of the machine; and a utilization environment load storing section with utilization environment load to parts of the machine stored therein in correspondence to utilization environment for the machine, in which the replacement possibility determining section searches the designed lifetime of parts stored in the designed lifetime storing section and load to the parts in a specific utilization environment stored in the utilization environment load storing section and determines the possibility of replacement based on the error information or the alarm information, the utilization record, designed lifetime, and utilization environment load.

Preferably, the supplemental parts production forecasting system of the present invention further includes: a stock number storing section with a stock number of the supplemental parts stored therein; and a stock number updating section for sequentially updating the stock number stored in the stock number storing section, in which the production forecasting section includes a stock checking section for checking the number of stocked supplemental parts stored in the stock number storing section when it is determined by the replacement possibility determining section that replacement of the parts is necessary; and a production instructing section for instructing production of the parts when it is determined by the stock checking section that the recognized number of stocked parts is not more than a prespecified parts.

According to another aspect of the present invention, a supplemental parts production forecasting method of forecasting production of supplemental parts to be replaced with the parts when any abnormality occurs in parts constituting the machine, the method includes: an error/alarm information fetching step of fetching error information or alarm information transmitted from the machine and indicating parts of the machine with the abnormality occurring therein and contents of the abnormality; a utilization record fetching step of fetching a utilization record for the machine transmitted from the machine; a utilization record accumulating step of sequentially accumulating the fetched utilization records; a replacement possibility determining step of determining, based on the error information or alarm information fetched in the error/alarm information fetching step and utilization records accumulated in the utilization record accumulating step, whether the parts with the abnormality occurring is an object for replacement with supplemental parts or not; and a supplemental parts production forecasting step of forecasting production of the supplemental parts to be replaced with the parts when it is determined in the replacement possibility determining step that replacement is required.

According to still another aspect of the present invention, a program for making a computer execute the above described supplemental parts production forecasting method of the present invention.

According to yet another aspect of the present invention, a recording medium stores the above described program of the present invention recorded in a manner readable by a computer.

### BRIEF DESCRIPTION OF THE DRAWINGS

FIG. 1 is a schematic view showing a supplemental parts production forecasting system according to an embodiment of the present invention;

FIG. 2 is a block diagram showing a construction machine in the embodiment;

FIG. 3 is a block diagram showing configuration of a server according to the embodiment;

FIG. 4 is a schematic view showing a database with registration information accumulated therein concerning types, models, machine numbers of construction machines according to the embodiment,

FIG. 5 is a schematic view showing a structure of an error information database with error code accumulated therein in correspondence to the machine numbers of the construction machines in the embodiment;

FIG. 6 is a schematic view showing a structure of an alarm information database with alarm code accumulated therein in correspondence to the machine numbers of the construction machines in the embodiment;

FIG. 7 is a schematic view showing an accumulated utilization time database with accumulated utilization time of the construction machines accumulated therein in the embodiment;

FIG. 8 is a schematic view showing a positional information database with positional data of the construction machines accumulated therein in the embodiment;

FIG. 9 is a schematic view showing a designed lifetime database with designed lifetime of parts for construction machines accumulated therein in the embodiment;

FIG. 10 is a schematic view showing an operating environment load database with lifetime information of the parts corresponding to operating environments accumulated therein;

FIG. 11 is a schematic view showing an actual demand database concerning actual demands for supplemental parts;

FIG. 12 is a schematic view showing a demand forecasting database for forecasted demand for the supplemental parts;

FIG. 13 is a schematic view showing a structure of a terminal computer;

FIG. 14 is a flow chart for illustrating actions of a supplemental parts production forecasting system in the embodiment; and

FIG. 15 is a flow chart for illustrating the supplemental parts production forecasting system in the embodiment.

### DETAILED DESCRIPTION OF PREFERRED EMBODIMENT(S)

An embodiment of the present invention is described below with reference to the related drawings.

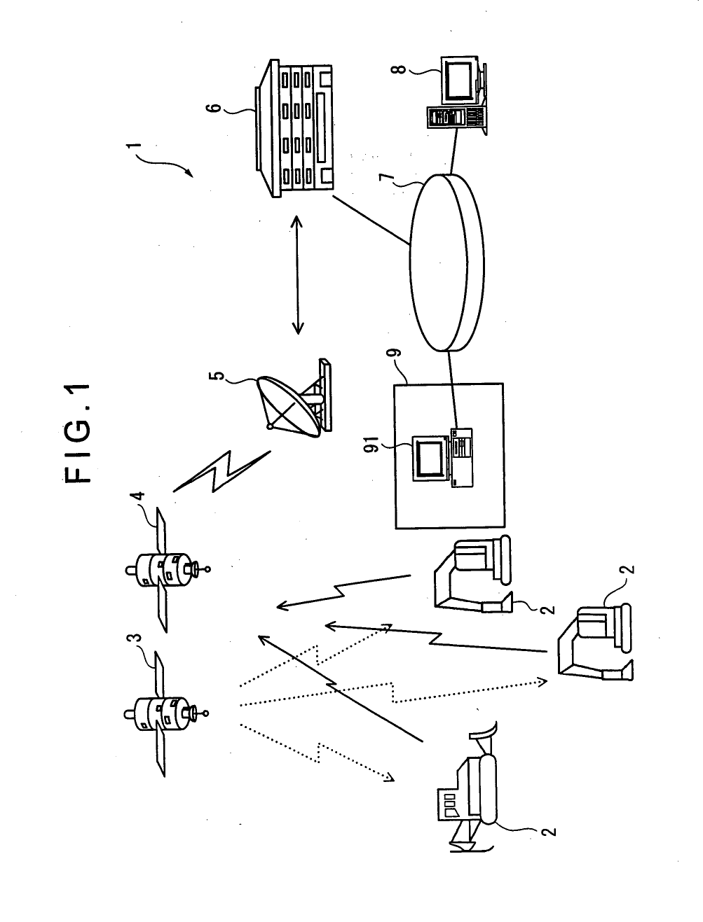

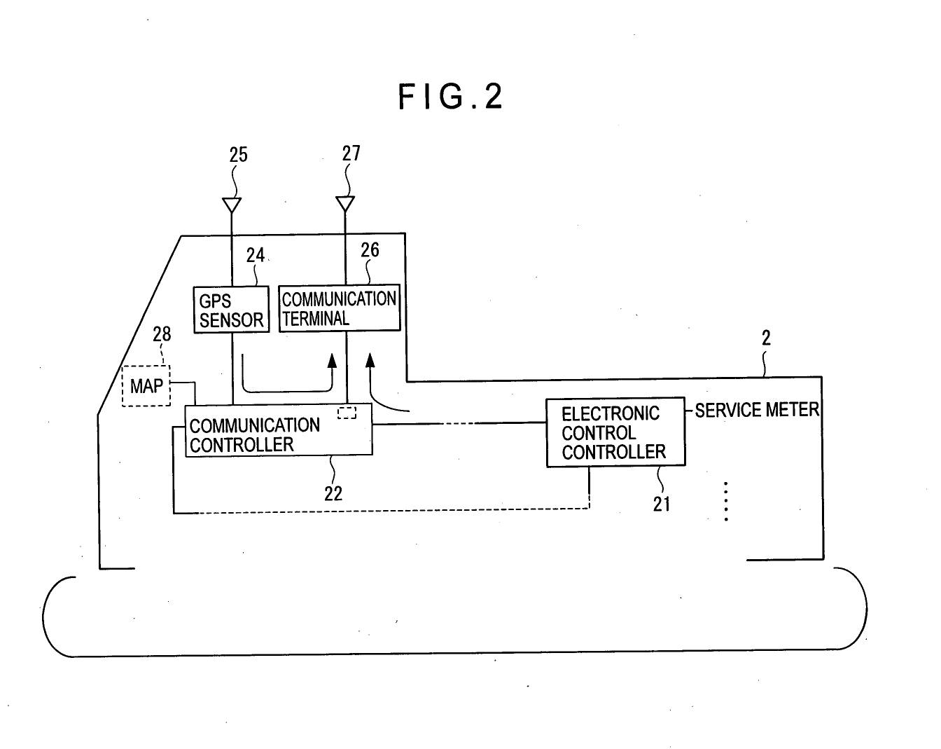

FIG. 1 is a schematic view showing a general configuration of a supplemental parts production forecasting system 1 according to the present invention. This supplemental parts production forecasting system 1 includes a plurality of construction machines 2, a GPS (Global Positioning System) satellite 3, a communication satellite 4, a satellites earth station 5, a network control station 6, a network 7, a server 8, and a production plant 9, and this system forecasts production of supplemental parts based on error information, alarm information, and utilization record of the construction machines and the like transmitted from the construction machines 2.

The construction machine 2 are those used for works such as excavating and leveling performed at a construction site such as a road, and the construction machines 2 such as bulldozer and power shovels include various types of driving components such as engines, hydraulic pumps, and butteries.

These driving components have sensors attached thereto respectively, and the construction machines 2 each includes an electronic control controller 21 for electronically controlling the driving components, and a communication controller 22 connected to this electronic control controller 21.

The electronic control controller 21 controls the driving components in response to signals from the sensor. Connected to this electronic control controller 21 is a service meter, and the utilization time of the construction machines 2 is detected by this service meter.

The communication controller 22, when an abnormal value is detected by any of the sensors described above, generates error information or alarm information indicating parts with abnormality occurred therein and contents of the abnormality, and outputs the error information or alarm information.

The error information as used herein indicates an error such as a failure of or a trouble in parts or a portion of the construction machine 2, and is classified to mechanical system error code indicating errors of mechanical parts and electric system error code indicating errors in electric parts. The alarm information alerts generation of prespecified abnormal phenomena such as overheating of water in an engine, abnormally low hydraulic pressure in an engine, and abnormally low charged voltage in a battery.

Also the utilization time detected by the service meter can be outputted from the communication controller 22.

Further, the communication controller 22 has a storage area therein, and machine numbers of the construction machines are stored in this storage area.

The construction machine 2 includes, in addition to the electronic control controller 21 and the communication controller 22, a GPS sensor 24. This GPS sensor 24 receives electric waves output from a plurality of GPS satellites 3 through a GPS antenna 25, and computes a current position of the sensor based on the received electric waves, and the positional information received by the GPS sensor 24 is output to the communication controller 22. Further, the current position information fetched by the GPS sensor 24 is combined with a map database not shown to display a map on an image display unit 28 of a navigation system.

Error information, alarm information, accumulated utilization, positional information, and machine numbers for the construction machines 2 are output via the communication controller 22, and further the information is output from a satellite communication antenna 27 via a communication terminal 26 to the server 8 via the communication satellite, satellites earth station 5, a network control station 6, and network 7.

The construction machines 2 can output the accumulated utilization time information or positional information at any point of time or at any interval, but generally the information should preferably be output at a starting time of a work, during a rest time, or at an end time of a work at the construction site.

When the error information or alarm information for the construction machines 2 is output, also the accumulated utilization time, positional information, and machine numbers of the construction machines 2 should preferably be output together. With this configuration, the server 8 can fetch the accumulated utilization time and positional information for the construction machines 2 when the error information or alarm information is output.

The network 7 is built through the Internet based on the general purpose protocol such as TCP/IP, and connected to this network 7 are, in addition to the network control station 6 and the server 8, a terminal computer 91 provided at the production plant 9 producing the supplemental parts as shown in FIG. 1.

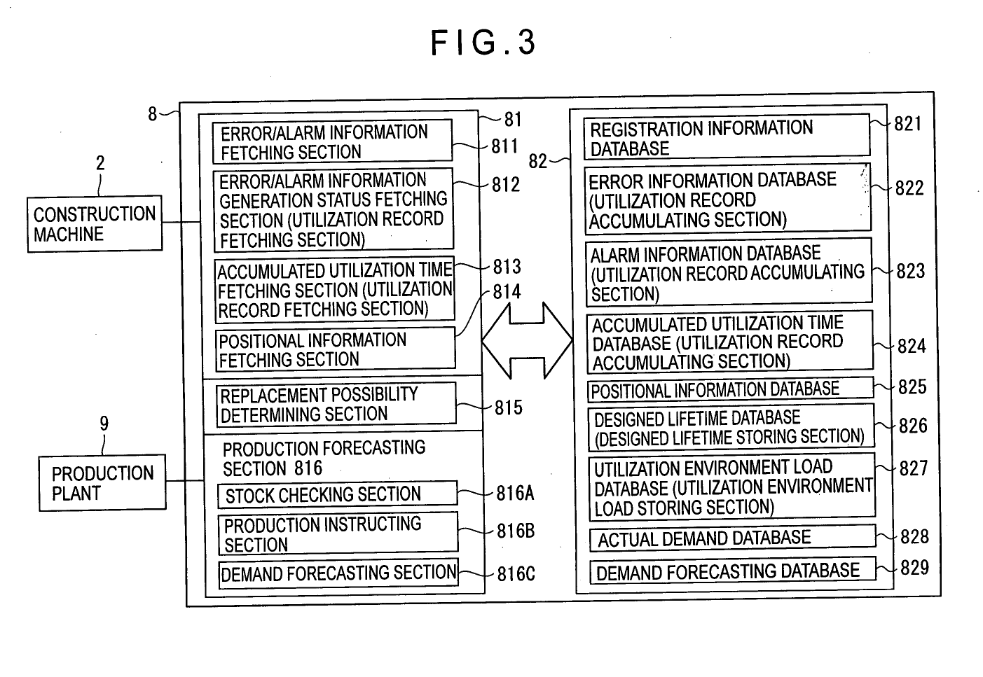

The server 8 is provided as a WWW (World Wide Web) server connected to the network 7, and includes a computing unit 81 capable of executing various programs and a storage device 82 such as a hard disk as shown in FIG. 3.

The computing unit 81 includes an error/alarm information fetching section 811, an error/alarm information generation status fetching section (utilization record fetching section) 812, an accumulated utilization time fetching section (utilization record fetching section) 813, a positional information fetching section 814, a replacement possibility determining section 815, and a production forecasting section 816.

The error/alarm information fetching section 811 includes an error information fetching section for fetching error information transmitted from the communication controller 22, and an alarm information fetching section for fetching alarm information, and fetches the error information and alarm information in correlation to machine numbers of the construction machines 2.

The error information fetched by the error information fetching section in the error/alarm information fetching section 811 is output as error code to an error information database 822 in the storage device 82. The alarm information fetched by the alarm information fetching section is output as alarm code (caution code) to an alarm information database 823 in the storage device 82.

The error code indicates parts in which any abnormality has occurred and contents of the abnormality with 6 digits of alphanumerical letters, while the alarm code indicates parts in which any abnormality has occurred and contents of the abnormality with, for instance, two digits of alphanumerical letters.

The error/alarm information generation status fetching section 812 includes an error information transmission status fetching section for detecting error information transmission times as utilization record of the construction machines transmitted from the communication controller 22 and an alarm information transmission status fetching section for detecting duration time of transmission of alarm information, and correlates the error/alarrn information to the error code, the alarm code, and the machine numbers of the construction machines, and respectively outputs the information to the error information database 822 and alarm information database 823.

The accumulated utilization time fetching section 813 fetches the accumulated utilization time as utilization record for the construction machines 2 transmitted from the communication controller 22 of the construction machines 2 in correlation to machine numbers of the construction machines 2, and stores the information in an accumulated utilization time database 824 in the storage device 82.

The positional information fetching section 814 fetches positional information for the construction machines 2, generates positional information by correlating machine numbers of the construction machines 2 with longitude information and latitude information, and outputs the positional information to a positional information database 825.

The replacement possibility determining section 815 determines whether any parts having transmitted the error information or alarm information is an object for replacement or not, based on the error information database 822, alarm information database 823, accumulated utilization time database 824, positional information database 825, and further on a designed lifetime database 826, and an utilization environment load database 827 described below.

For instance, replacement possibility determining section 815 determines a utilization site of the construction machines 2 from the positional information stored in the positional information database 825, searches and reads out information concerning a load (lifetime of parts in the utilization site) to the parts the utilization site from the utilization environment load database. When it is determined that the parts having transmitted error information or alarm information has expired the lifetime, that the accumulated utilization of the construction machine has surpassed the prespecified period of time, or that the times of transmission of error information has surpassed the prespecified times or duration of transmission of the alarm information has surpassed a prespecified period of time, the replacement possibility determining section 815 determines that the parts having transmitted the error information or alarm information is an object for replacement with supplemental parts.

When it is determined by the replacement possibility determining section 815 that the parts having transmitted the error information or alarm information is an object for replacement, the production forecasting section 816 forecasts the needs for production of supplemental parts, and includes a stock checking section 816A, a production instructing section 816B, and a demand forecasting section 816C.

When it is determined by the replacement possibility determining section 815 that the parts having transmitted the error information or alarm information is an object for replacement, the stock checking section 816A reads out and fetches the number of stocked supplemental parts stored in a stock number storing section 911A1 (described hereinafter) in a terminal computer 91 at the production plant 9.

When the number of stocked supplemental parts fetched by the stock checking section 816A is less than a prespecified number, the production instructing section 816B issues an instruction for production of supplemental parts to the production plant 9.

When the instruction for production is issued from the production instructing section 816B, a demand forecasting database 829 in the storage device 82 described hereinafter is updated.

The demand forecasting section 816C forecasts a minimum quantity of supplemental parts to be produced within a current year based on the actual demand in the past stored in an actual demand database 828 in the storage device 82, the number of units of the construction machines 2 (the number of units of construction machines 2 being utilized) with the accumulated utilization time updated in the accumulated utilization time database 824, and other information.

The storage device 82 includes a registration information database 821 with types, models an machine numbers of the construction machines 2 registered therein; the error information database (utilization record accumulating section) 822, the alarm information database (utilization record accumulating section) 823, the accumulated utilization time database (utilization record accumulating section) 824, the positional information database 825, the designed lifetime database (designed lifetime storing section) 826, the utilization environment load database (utilization environment load storing section) 827, the actual demand database 828, and the demand forecasting database 829.

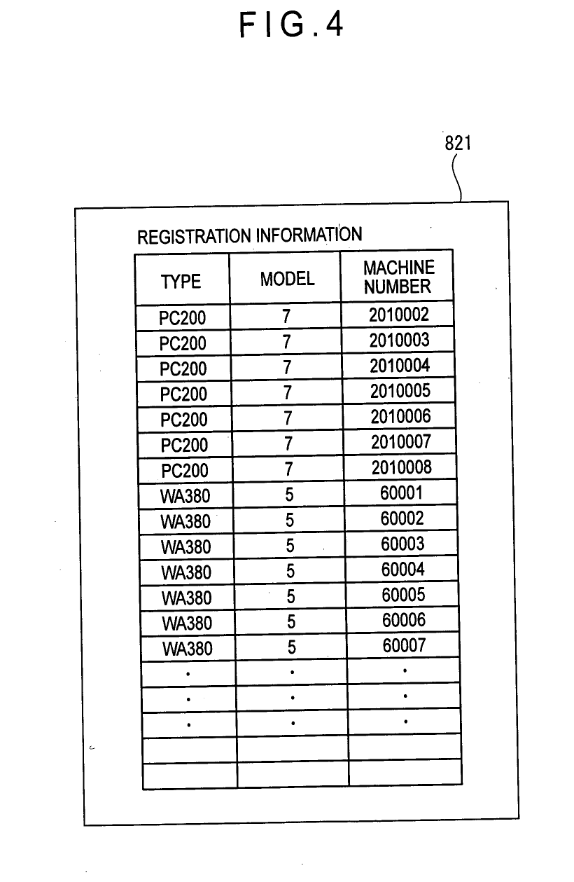

The registration information database 821 is a database in which information concerning types, models, and machine numbers of the construction machines 2 has been accumulated and has a table structure as shown in FIG. 4.

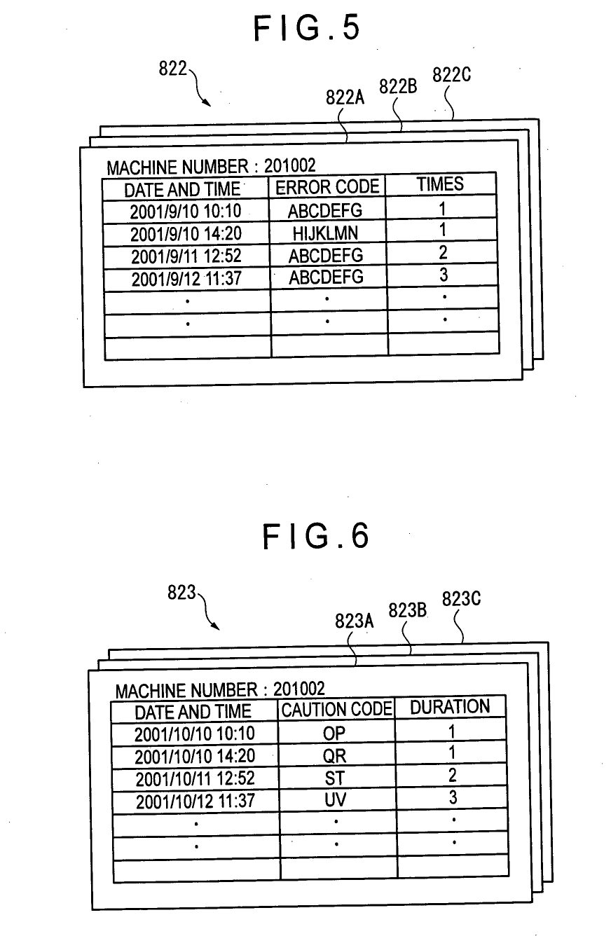

The error information database 822 has a plurality of tables 822A, 822B, 822C . . . set therein as shown in FIG. 5 in correspondence to the machine numbers of the construction machines 2 registered in the registration information database 821, and stores therein the error code output from the error/alarm information fetching section 811 in correspondence to the machine numbers of the construction machines 2.

Also, times of transmission of the error information fetched by the error/alarm information generation status fetching section 812 is stored in the error information database 822.

In short, date and time when the error information is received, error code, times of generation of error information are accumulated in the error information database 822.

The alarm information database 823 has a plurality of tables 823A, 823B, 823C . . . set therein as shown in FIG. 6 in correspondence to the machine numbers of the construction machines 2 registered in the registration information database 821, and stores therein alarm codes output from the error/alarm information fetching section 811 in correspondence to the machine numbers of the construction machines 2.

The alarm information database 823 also stores therein information concerning the duration time of transmission of the alarm information fetched by the error/alarm information generation status fetching section 812.

In short, the date and time when the alarm information is fetched, alarm code, and duration time of transmission of the alarm information are accumulated in the alarm information database 823 as shown in FIG. 6.

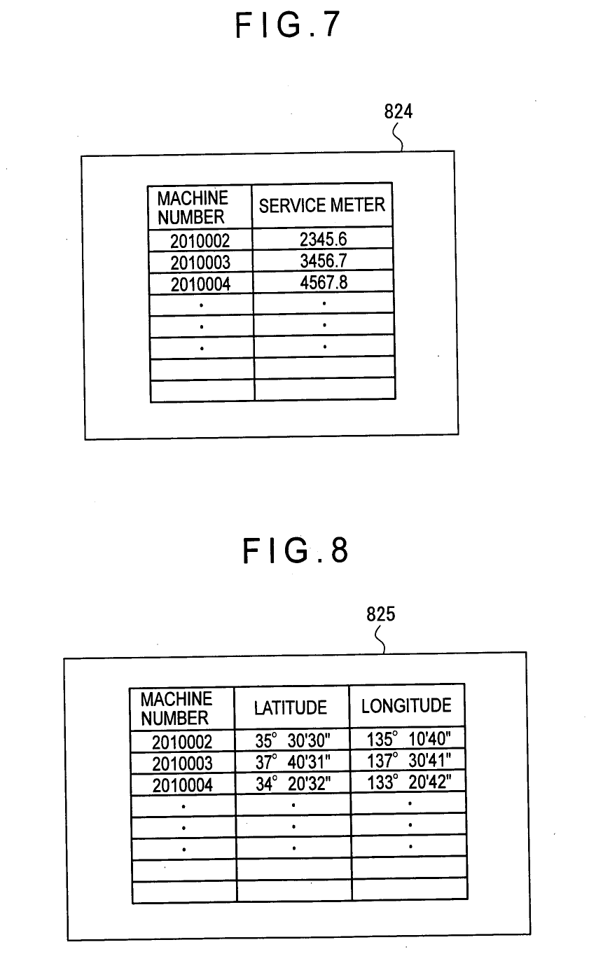

The accumulated utilization time database 824, as shown in FIG. 7, accumulates therein the accumulated utilization time (a value indicated by a service meter) fetched by the accumulated utilization time fetching section 813 for each machine number of the construction machines 2 registered in the registration information database 821, and has a table structure with accumulated utilization time of the construction machines 2 for each machine number stored therein as one record.

Each record can be updated at each time when the information concerning the accumulated utilization time is fetched by the accumulated utilization time fetching section 813.

The positional information database 825, as shown in FIG. 8, fetches the positional information fetched by the positional information fetching section 814 for each machine number of construction machines 2 registered in the registration information database 821, and has a table structure for storing therein longitude information and latitude information of the construction machines corresponding to the machine numbers fetched by the positional information fetching section 814 as one record.

Each record can be updated at each time when the longitude information and latitude information are fetched by the positional information fetching section 814.

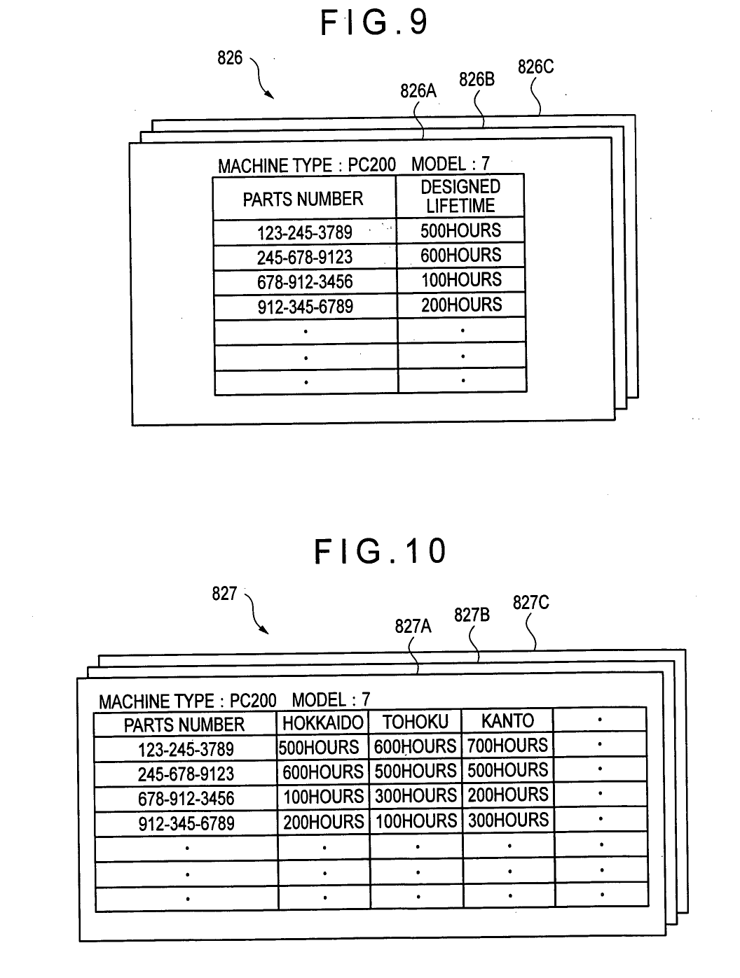

The designed lifetime database (designed lifetime storing section) 826 has a plurality of tables 826A, 826B, 826C . . . set therein as shown in FIG. 9 in correspondence to machine types and models of the construction machines 2 registered in the registration information database 821 and stores therein designed lifetime of each of parts in correspondence to machine types and models of the construction machines 2. A parts number is assigned to each of parts, and the database has a table structure for storing therein the design lifetime information as one record.

The utilization environment load database (utilization environment load storing section) 827 accumulates therein information concerning load in utilization environment to parts corresponding to types and models of the construction machines 2 as a plurality of tables 827A, 827B, 827C, . . . as shown in FIG. 10. Design lifetime of each of parts is stored therein in correspondence to each utilization area. Information concerning parts not generating any difference in the actual lifetime from the designed lifetime depending on the environment for utilization is not registered in the utilization environment load database 827.

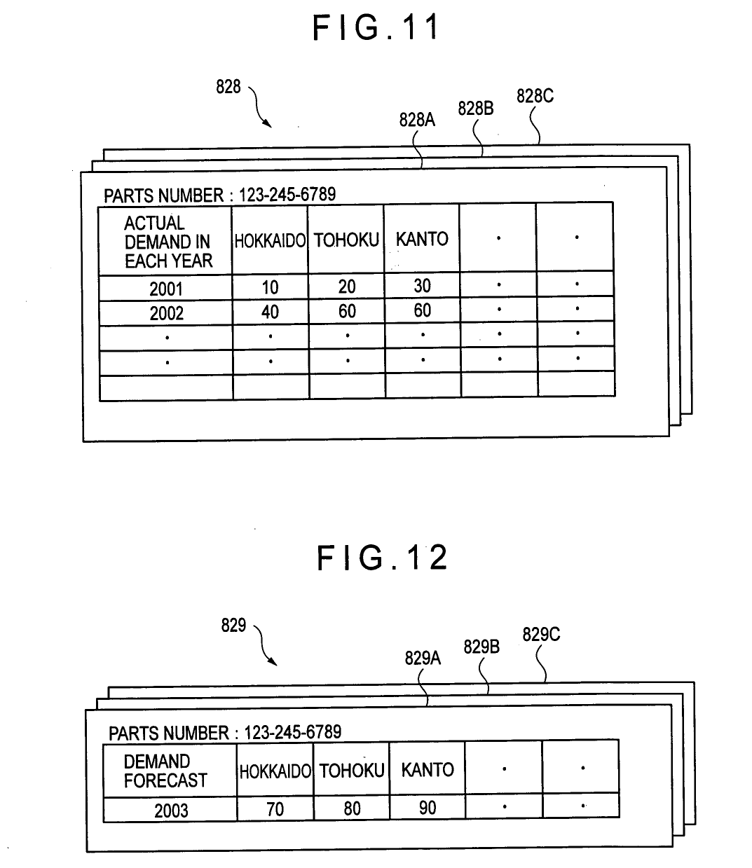

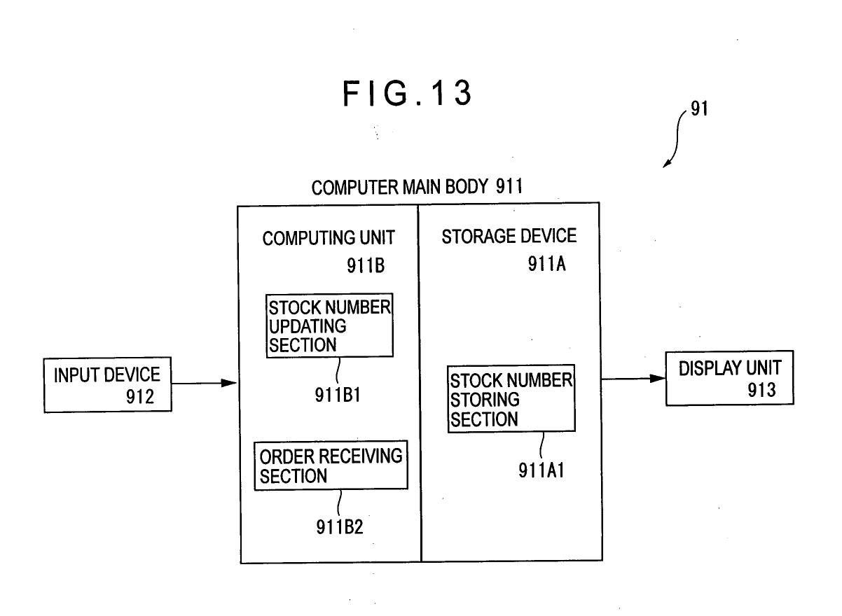

The actual demand database 828 accumulates therein actual demand in each area for parts corresponding to types and models of the construction machines 2 registered in the registration information database 821 as a plurality of tables 828A, 828B, 828C . . . as shown in FIG. 11.

The demand forecasting database 829 stores therein demand forecasting for supplemental parts to be supplied within a current year based on the actual demand data stored in the actual demand database 828 in the demand forecasting section 816C as shown in FIG. 12. The demand forecasting database 829 accumulates therein information for parts demand forecast in each area for parts corresponding to types and models of the construction machines 2 registered in the registration information database 821 as a plurality of tables 829A, 829B, 829C . . . .

Before an instruction for production is issued by the production instructing section 816B, a minimum demand number forecasted by the demand forecasting section 816C is registered in this demand forecasting database 829. This value is updated according to an instruction from the production instructing section 816B.

The terminal computer 91 provided at the production plant 9 is a general purpose computer including a computer main body 911 having a computing unit 911B and a storage device 911A, an input device 912 such as a keyboard or a mouse connected to this computer main body 911, and a display unit 913 such as a display, and can communicate with the server 8 through the network 7.

A storage device 911A of the computer main body 911 in this terminal computer 91 includes a stock number storing section 911A1 with the number of stocked supplemental parts stored therein.

A computing unit 911B of the computer main body 911 has a stock number updating section 911B 1 for sequentially updating the number of stocked parts stored in the stock number storing section 911A1. Further, the computing unit 911B has an order receiving section 911B2 for fetching information concerning instruction for production from a production instructing section 816B in the server 8, and when information concerning an instruction for production is received by this order receiving section 911B2, production of the supplemental parts is started in the production plant 9.

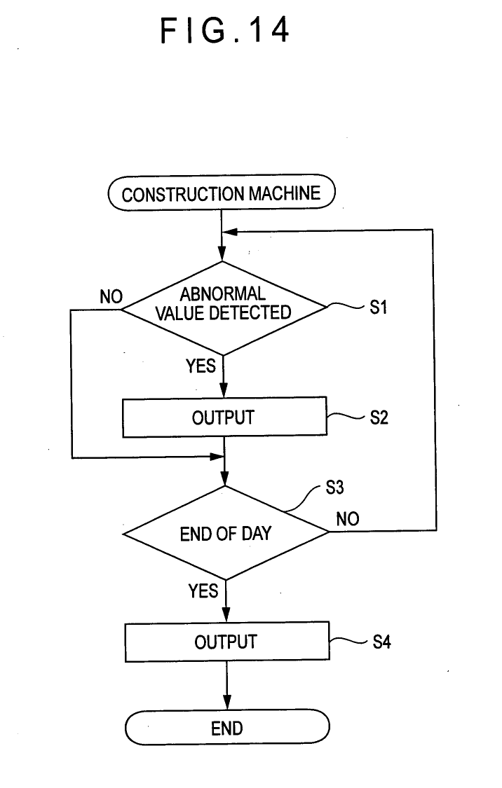

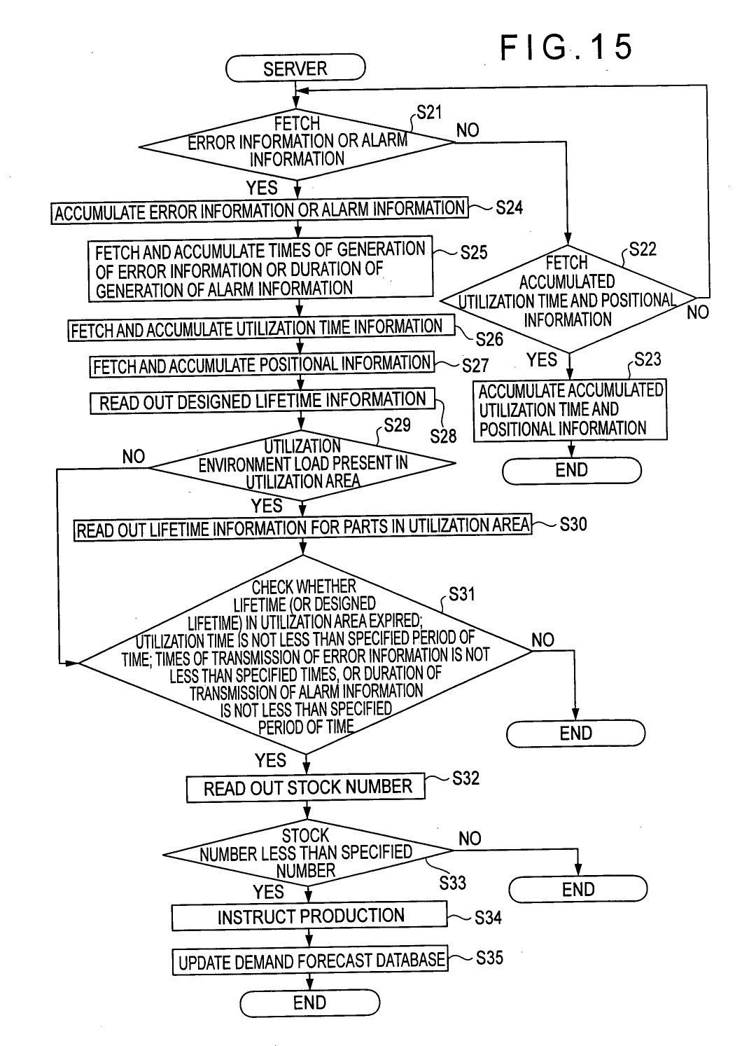

Actions of the supplemental parts forecasting system 1 as described above will be described below with reference to FIG. 14 and FIG. 15 below.

At first, the construction machine 2 determines whether an abnormal value is detected by any sensor provided in parts of the construction machine 2 or not (step S1).

When the communication controller 22 of the construction machine 2 detects an abnormal value indicated by the sensor provided in any parts of the construction machine 2, the communication controller 22 generates error information or alarm information, and outputs the information to the server 8 (step S2).

In this step, positional information for the construction machine 2 at the point of time when the abnormal value of the sensor is detected, and also information concerning accumulated utilization time, a type, a model, a machine number of the construction machine 2 are output to the server 8.

When any abnormal value is not detected by the sensor, or after error information or alarm information is generated and output to the server 8, the construction machine 2 determines whether a daily work for a current day has been finished or not (step S3), and when it is determined that the daily work has been finished, the positional information for the construction machine 2 and the accumulated utilization time of the construction machine 2 are output as information indicating a state of the construction machine 2 on the same day to the server 8 (operation S4).

The server 8 determines, as shown in FIG. 15, whether error information or alarm information has been fetched by the error/alarm information fetching section 811 or not (step S21).

When it is determined that error information or alarm information has not been fetched, the server 8 determines whether accumulated utilization time and positional information transmitted from the construction machine 2 after the end of daily work has been fetched by the accumulated utilization time fetching section (utilization record fetching section) 813 and positional information fetching section 814 or not (step S22). When it is determined that the information concerning accumulated utilization time and positional information have not been fetched, the system control returns to the step S21 again.

When it is determined that the information concerning accumulated utilization time and positional information have been fetched, the information concerning the accumulated utilization time is stored in the accumulated utilization time database 824. Further, the positional information is accumulated in the positional information database 825 (step S23).

On the other hand, when it is determined that the error information or alarm information has been fetched, this information is stored in the error information database 822 or in the alarm information database 823 (step S24).

Further, the server 8 fetches times of transmission of error information or duration of transmission of alarm information with the error/alarm information generation status fetching section 812 (step S25, a utilization record fetching step), and stores the information in the error information database 822 or in the alarm information database 823.

Further, the server 8 fetches the information concerning the accumulated utilization output from the construction machine 2 together with the error information or alarm information with the accumulated utilization time fetching section 813 (step S26, an accumulated utilization record fetching step), and stores the information in the accumulated utilization time database 824.

The positional information fetching section 814 in the server 8 fetches the positional information output from the construction machine 2 together with the error information or alarm information (step S27, a positional information fetching step), and stores the information in the positional information database 825.

Then the replacement possibility determining section 815 in the server 8 reads out a designed lifetime of the parts having transmitted the error information or alarm information from the designed lifetime database 826 (step S28, a designed lifetime read-out step).

Further, the replacement possibility determining section 815 reads out the positional information accumulated in the positional information database 825, and determines a utilization area for the construction machine 2 based on the positional information.

Then the replacement possibility determining section 815 determines whether the designed lifetime of the parts having transmitted the error information or alarm information in the utilization area has been stored in the utilization environment load database 827 or not (step S29), and when it is determined that the designed lifetime information for the parts in the utilization area has been stored, the server 8 reads out the lifetime (step S30, a load read-out step).

When it is determined that the designed lifetime information for the parts in the utilization area has not been stored in the utilization environment load database 827, the replacement possibility determining section 815 determines the necessity of replacement with the replacement possibility determining section 815 based on the designed lifetime.

The replacement possibility determining section 815 reads out times of transmission of error information or duration of transmission of alarm information from the error information database 822 and the alarm information database 823 respectively, and further reads out the accumulated utilization time from the accumulated utilization time database 824.

The replacement possibility determining section 815 determines whether the parts having transmitted the error information or alarm information has expired the lifetime defined to the utilization area (or designed lifetime) or not, whether the accumulated utilization time of the construction machine 2 has surpassed the prespecified accumulated utilization time or not, and whether the times of transmission of error information or the duration of transmission of alarm information is not less than a prespecified value or not. When the conditions are satisfied, the replacement possibility determining section 815 determines that the parts having transmitted the error information or alarm information is an object for replacement with supplemental parts (step S31, a replacement possibility determining step).

When the above conditions are not satisfied, the replacement possibility determining section 815 determines that the parts having transmitted the error information or alarm information is not an object for replacement with supplemental parts (step S31, a replacement possibility determining step).

When it is determined that the parts having transmitted the error information or alarm information is an object for replacement with supplemental parts with the replacement possibility determining section 815, the stock checking section 816A in the server 8 reads out and fetches the number of stocked supplemental parts from the stock number storing section 911A1 of the terminal computer 91 at the production plant 9.

When it is determined that the number of stocked supplemental parts fetched by the stock checking section 816A is not more than the specified number (step S33, a production forecasting step), the production instructing section 816B issues an instruction for production of the supplemental parts to the production plant (step S34, a production forecasting step). Information for this instruction for production is fetched by the order receiving section 9111B2 in the terminal computer 91.

When production of the supplemental parts is instructed by the production instructing section 816B, the demand forecasting database 829 in the storage device 82 in the server 8 is updated (step S35).

As described above, the supplemental parts instructed to be produced and produced at the production plant 9 is sent to a service center or the like in the area where the construction machine 2 is utilized based on the positional information fetched by the positional information fetching section 814 in the server 8.

When it is determined that the number of stocked supplemental parts fetched by the stock checking section 816A is more than the specified number (step S33, a production forecasting step), the supplemental parts is sent to a service center or the like in the area where the construction machine 2 is utilized from a warehouse in the production plant 9 based on the positional information fetched by the positional information fetching section 814 in the server 8.

With the embodiment described above, the following advantages can be obtained.

(1) The server 8 determines whether any parts having transmitted error information or alarm information is an object for replacement or not based on generation status of the error information or alarm information, information concerning the accumulated utilization of the construction machine 2 and the like with the replacement possibility determining section 815, so that the server 8 can forecast the production of the supplemental parts according to the current state of the utilized construction machine 2. Therefore, excessive production and shortage of the supplemental parts can be prevented, so that a production quantity for the supplemental parts can be optimized. Further, as excessive production of the supplemental parts can be prevented, also the maintenance cost for a warehouse or the like for accommodating the supplemental parts can be reduced.

(2) In some situations such as when the accumulated utilization time of the construction machine 2 is short, when a value indicating the times of generation of error information is still small, or when the duration of transmission of alarm information is short, even when the error information or alarm information is generated, the parts are not required to be replaced immediately and production of the supplemental parts is not required at once.

In this embodiment, when the times of generation of error information is not less than the prespecified value, or when the duration of transmission of the alarm information is not shorter than the prespecified period of time and further the accumulated utilization time is longer than the prespecified period of time, namely based on deliberate considerations of the utilization record, it is determined that the parts with any abnormality occurring therein is an object for replacement, so that accurate determination can be made. Because of this feature, a production quantity of the supplemental parts can be optimized. Therefore, the number of stocked supplemental parts can be maintained in the optimal state.

(3) The construction machine 2 has the GPS sensor 24, so that the positional information fetching section 814 in the server 8 can fetch positional information for the construction machines 2. Because of this feature, a utilization area of each of the construction machine 2 can be identified, and further a supply area for the supplemental parts can be identified. Therefore, the supplemental parts can appropriately be supplied to each area needing the same, so that excessive or short supply of the supplemental parts in each area can be eliminated.

(4) The replacement possibility determining section 815 in the server 8 determines a utilization area for each construction machine 2 from the positional information stored in the positional information database 825, and reads out a load (a lifetime of the parts at the current utilization site) to the parts in the utilization area from the utilization environment load database 827. Further, the replacement possibility determining section 815 makes the determination taking into considerations the lifetime of the parts having transmitted the error information or alarm information in the current utilization area, so that the replacement possibility determining section 815 can make an accurate determination based on the actual utilization of the construction machine 2. Because of this feature, a production quantity of supplemental parts can be optimized. Therefore, stock of supplemental parts can be maintained in the optimal state.

(5) Further, the server 8 includes the stock checking section 816A for checking stock of the supplemental parts at the production plant 9, and issues an instruction for production of the supplemental parts with the production instructing section 816B only when the stock is below the prespecified value. Because of this feature, stock of supplemental parts can be optimized.

Incidentally, the scope of the present invention is not restricted to the above-described embodiments, but includes modifications and improvements as long as an object of the present invention can be achieved.

In the embodiment described above, the replacement possibility determining section 815 reads out a load to parts in a utilization area (lifetime of parts at the position of utilization) from the utilization environment load database 827 and makes determinations taking into considerations the lifetime of parts having transmitted error information or alarm information in the utilization area, but the present invention is not limited to this configuration, and for instance the determination may be made by taking into considerations a load (utilization environment load) by an operator using the construction machine 2 instead of the load in the utilization area. For instance, the configuration is allowable in which information concerning the operating state of construction machines 2 by each operator (concerning whether the use of the construction machines 2 is rough or careful) is accumulated in the utilization environment load database and determinations for possibility of replacement are made based on the data.

The utilization environment load is not always required to be taken into considerations, and the configuration is allowable in which only the designed lifetime is taken into considerations. In this case, the utilization environment load database 827 is not required.

Further, in the embodiment described above, the GPS sensor 24 is provided in each of the construction machines 2, and positional information is fetched by the server 8, but the present invention is not limited to this configuration, and the GPS sensor 24 or the like is not always required. With the configuration, cost for the supplemental parts production forecasting system can be reduced.

Further, in the present invention, the stock number storing section 911A1 with the number of stocked supplemental parts stored therein and the stock number updating section 911B1 for updating the number of stocked supplemental parts are provided in the terminal computer 91 at the production plant 9, but the present invention is not limited to this configuration, and the components may be provided in the server 8. In this case, operations such as checking the number of stocked parts can be carried out in the server 8.

In the embodiment described above, the information from the construction machines 2 is output via the communication satellite 4, satellite earth station 5, and network control station 6 to the server 8, but the present invention is not limited to this configuration, and the information may be transmitted by making use of a public communication network such as PHS, and the information sent through a radio network may be received by a terminal computer or the like connected to the network and transmitted to the server 8 from the terminal computer via the network.

The priority application Number JP2003-4133314 upon which this patent application is based is hereby incorporated by reference.

1. A supplemental parts production forecasting system for forecasting production, when an abnormality occurs in parts constituting a machine, of supplemental parts to be replaced with the parts comprising:
an error/alarm information fetching section for fetching error information or alarm information transmitted from the machine and indicating parts with abnormality and contents of the abnormality in the machine;
a utilization record fetching section for fetching utilization record of the machine transmitted from the machine;
a utilization record accumulating section for sequentially accumulating the fetched utilization records;
a replacement possibility determining section for determining whether the parts with the abnormality generated therein is an object for replacement with supplemental parts or not based on the error information or alarm information fetched by the error/alarm fetching section as well as on the utilization record accumulated in the utilization record accumulating section; and
a production forecasting section for forecasting production of the supplemental parts to be replaced with the parts when it is determined that replacement of the parts is necessary by the replacement possibility determining section.

2. The supplemental parts production forecasting system according to claim 1, wherein the utilization record includes times of transmission of the error information or duration of transmission of the alarm information from the machine.

3. The supplemental parts production forecasting system according to claim 1, wherein the utilization record includes accumulated utilization time of the machine.

4. The supplemental parts production forecasting system according to claim 1 further comprising:
a positional information fetching section for fetching information concerning a position of utilization of the machine transmitted from the machine.

5. The supplemental parts production forecasting system according to claim 1 further comprising:
a designed lifetime storing section for storing therein designed lifetimes for parts of the machine; and
a utilization environment load storing section with utilization environment load to parts of the machine stored therein in correspondence to utilization environments for the machine,
wherein the replacement possibility determining section searches the designed lifetime of parts stored in the designed lifetime storing section and load to the parts in a specific utilization environment stored in the utilization environment load storing section and determines the possibility of replacement based on the error information or the alarm information, the utilization record, designed lifetime, and utilization environment load.

6. The supplemental parts production forecasting system according to claim 1 further comprising:
a stock number storing section with a stock number of the supplemental parts stored therein; and
a stock number updating section for sequentially updating the stock number stored in the stock number storing section,
wherein the production forecasting section comprises a stock checking section for checking the number of stocked supplemental parts stored in the stock number storing section when it is determined by the replacement possibility determining section that replacement of the parts is necessary; and
a production instructing section for instructing production of the parts when it is determined by the stock checking section that the recognized number of stocked parts is not more than prespecified parts.

7. A supplemental parts production forecasting method of forecasting production of supplemental parts to be replaced with the parts when any abnormality occurs in parts constituting the machine, the method comprising:
an error/alarm information fetching step of fetching error information or alarm information transmitted from the machine and indicating parts of the machine with the abnormality occurring therein and contents of the abnormality;
a utilization record fetching step of fetching a utilization record for the machine transmitted from the machine;
a utilization record accumulating step of sequentially accumulating the fetched utilization records;
a replacement possibility determining step of determining, based on the error information or alarm information fetched in the error/alarm information fetching step and utilization records accumulated in the utilization record accumulating step, whether the parts with the abnormality occurring is an object for replacement with supplemental parts or not; and
a supplemental parts production forecasting step of forecasting production of the supplemental parts to be replaced with the parts when it is determined in the replacement possibility determining step that replacement is required.

8. A program for making a computer execute a supplemental parts production forecasting method of forecasting production of supplemental parts to be replaced with the parts when any abnormality occurs in parts constituting the machine, the method comprising
an error/alarm information fetching step of fetching error information or alarm information transmitted from the machine and indicating parts of the machine with the abnormality occurring therein and contents of the abnormality;
a utilization record fetching step of fetching a utilization record for the machine transmitted from the machine;
a utilization record accumulating step of sequentially accumulating the fetched utilization records;
a replacement possibility determining step of determining, based on the error information or alarm information fetched in the error/alarm information fetching step and utilization records accumulated in the utilization record accumulating step, whether the parts with the abnormality occurring is an object for replacement with supplemental parts or not; and
a supplemental parts production forecasting step of forecasting production of the supplemental parts to be replaced with the parts when it is determined in the replacement possibility determining step that replacement is required.

9. A recording medium storing a program recorded in a manner readable by a computer
wherein the program makes a computer execute a supplemental parts production forecasting method of forecasting production of supplemental parts to be replaced with the parts when any abnormality occurs in parts constituting the machine, the method comprising
an error/alarm information fetching step of fetching error information or alarm information transmitted from the machine and indicating parts of the machine with the abnormality occurring therein and contents of the abnormality;
a utilization record fetching step of fetching a utilization record for the machine transmitted from the machine;
a utilization record accumulating step of sequentially accumulating the fetched utilization records;
a replacement possibility determining step of determining, based on the error information or alarm information fetched in the error/alarm information fetching step and utilization records accumulated in the utilization record accumulating step, whether the parts with the abnormality occurring is an object for replacement with supplemental parts or not; and
a supplemental parts production forecasting step of forecasting production of the supplemental parts to be replaced with the parts when it is determined in the replacement possibility determining step that replacement is required.
